(19) United States
(12) Patent Application Publication
(10) Pub. No.: US 2013/0117074 A1
(43) Pub. Date: May 9, 2013

(54) METHOD AND SYSTEM TO MEASURE OPERATIONAL EFFICIENCY LEVELS OF BUSINESS FUNCTIONS

(71) Applicants: Sarojini Damodaran Shibulal, Bangaloare (IN); Sanjay Purohit, Jodhpur (IN)

(72) Inventors: Sarojini Damodaran Shibulal, Bangaloare (IN); Sanjay Purohit, Jodhpur (IN)

(73) Assignee: INFOSYS LIMITED, Bangalore (IN)

(21) Appl. No.: 13/450,431

(22) Filed: Apr. 18, 2012

(30) Foreign Application Priority Data
Nov. 9, 2011 (IN) 3844/CHE/2011

(51) Int. Cl. G06Q 10/06

(52) U.S. Cl. 705/7.36

(57) ABSTRACT

A method, implemented at least in part by a computing device to measuring operational efficiency levels of business functions the method comprising acquiring a plurality of business data from at least one database, wherein the plurality of business data is indicative of a pre-defined set of business parameters for one or more business functions. The method also comprises the step of analyzing the plurality of business data by at least one processor based on the pre-defined weightage for each of the business parameters and the plurality of business data. Furthermore, the method comprises generating a customizable report based on the analysis of the plurality of business data to obtain relative ranking of one or more of the business functions.

### RELATED APPLICATION DATA

This application claims priority to Indian Patent Application No. 3844/CHE/2011, filed Nov. 9, 2011, which is hereby incorporated by reference in its entirety.

### TECHNICAL FIELD

The present disclosure relates to a method and system to measuring operational efficiency levels of various business functions in a large organization and come up with relative ranking of these business functions. The method focuses on measuring the level of adherence & compliance to various predefined set of business processes.

### BACKGROUND

Consistency is not observed in the way efficiency of process compliance reported by various business units. Each unit followed their own logic which was not consistent and hence it was difficult to compare the Operational performance of various business units and identify and address the areas of improvement. Also, there was no single formal mechanism to identify and measure the process compliance for various business units and compare them across units. The parameters used in various business units were not uniform and did not cover all the relevant functional areas. The mechanisms that were being used by the units were also much localized in nature and hence were not comparable, scalable and sustainable.

### SUMMARY OF THE INVENTION

According to the one aspect of the present disclosure, a method, implemented at least in part by a computing device, comprises of acquiring multiple business data from one or more databases. This business data is indicative of a pre-defined set of business parameters for one or more business functions. The business data is a set of business objects and these business objects are analyzed by an algorithm which assigns a 1 or 0 as a binary value to them based on some predefined business rules. Furthermore, a weighted value is assigned to each of the business objects based on the binary indicative value. Finally it computes a final weight for all the plurality of business objects, where the final weight is the weighted summation of all the plurality of business objects. The embodiment of the present disclosure also comprises the step of analyzing a set of business data by at least one processor based on the pre-defined weightage for each of the business parameters and the plurality of business data. The step of analyzing also involves analyzing performing at least or in combination of computing a trend graph, measuring a performance of a business function over a time and performing a statistical analysis of the business function. Furthermore, the embodiment of the present disclosure further comprises generating a customizable report based on the analysis of the plurality of business data to obtain relative ranking of one or more of the business functions. The report can also be configured or changed based on a particular requirement. The operational efficiency can be predicted or computed of a business function or the entire company.

Another embodiment of the present disclosure also comprises identifying critical business processes and defining a metrics for each of the critical business processes. The metrics can also be configured to be changed dynamically.

In another embodiment of the present disclosure another specific processor can be used to handle multiple exceptions while analyzing multiple business data.

In yet another embodiment of the present disclosure, a rank can be assigned to one or more business functions, wherein the rank is assigned based on the adherence of the one or more business function to business compliance.

### DRAWINGS

These and other features, aspects, and advantages of the disclosed embodiment will be better understood when the following detailed description is read with reference to the accompanying drawings in which like characters represent like parts throughout the drawings, wherein:

FIG. 1 is an example embodiment of the present disclosure;

FIG. 2 another example embodiment of the present disclosure;

FIG. 3 is a block diagram illustrating OEI index and process; and

FIG. 4 is a system illustrating a generalized computer network arrangement, in accordance with a disclosed embodiment.

### DETAILED DESCRIPTION

Prior to the introduction of this approach there was no standard and consistent way of measuring the efficiency of process compliance across the various business units. As the size of the business grew, there was a need for a new framework that would facilitate measurement of the process efficiency and facilitate identify areas of improvement. The selection of the processes and the business rules applied were to help in better predictability and scalability of critical business processes of the organization. It was important that this framework could be applied to all the business units in a uniform and consistent manner.

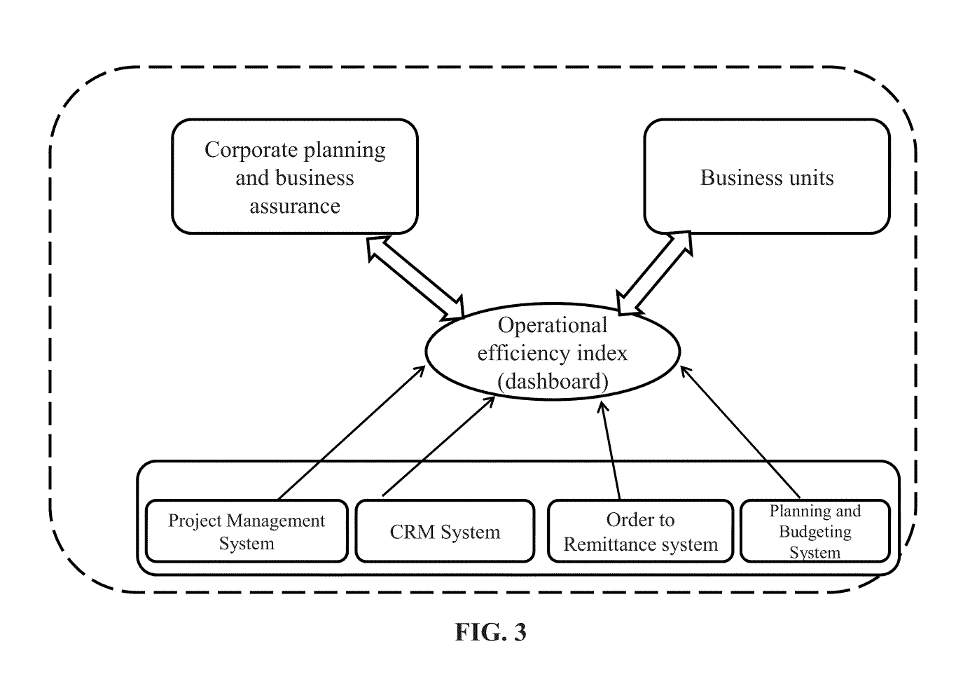

The new approach can be explained using FIG. 3. The advantages of this approach could be but not restricted to adequate coverage of critical processes across delivery, sales and planning functions, standardized list of process compliance parameters that can be measured across units, consistent business rules for obtaining compliance scores across units and their subsequent ranking, scalable and predictable approach to scoring even as the company grows bigger in size and geographical spread and ability to introduce new parameters/modify existing parameters quite easily without altering the overall framework.

The method disclosed focuses on measuring the extent or level of adherence to processes. All the identified metrics have a business rule defined for scoring on that metric. For all the metrics, the scoring clearly follows a binary scale; some of these metrics have sub-metrics as well. All this helps to make this framework and the index scalable and sustainable.

Significant benefits of the disclosed embodiment include, top/senior management as well as corporate functions getting good insights into the Operational efficiency levels of the various business units, the process owners getting to identify pain points in the current processes and fine tuning them for driving higher compliance and the Business units implementing corrective actions on the process areas that required improvement. The OEI compliance brings in an operational discipline in the organization. If OEI is taken out of the system, then this whole discipline may wither away which in turn may pose a stumbling block for the Business Units and the organization for achieving their respective Business goals (Financial/Operational)'.

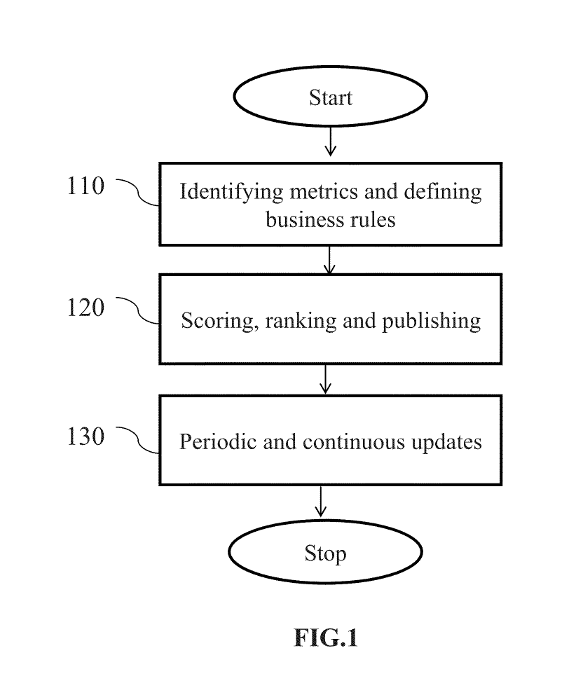

FIG. 1 is an example embodiment of the present disclosure. The step 110 explains the identification of critical processes in each of the major line functions—Planning, Sales and Delivery (Operations). Example of one such process is units providing confirmations to Finance of raising the invoice to the Customers every month based on the project deliverables. This process has an impact on the Cash Flow of the organization. For customer to process the payment on time it is important that the invoices reach him as per the timelines. Data source for this metric such as the billing cycle data for each projects is sourced from the internal OTR system and the frequency of this metric is set monthly as project billing is done once a month for most cases. Here the business rule is defined to facilitate timely completion of the internal activity related to customer invoicing as per the scheduled contractual terms. The rule reads Activity (Effort) confirmations for projects have to be completed within the published timelines for at least 95% of relevant projects.

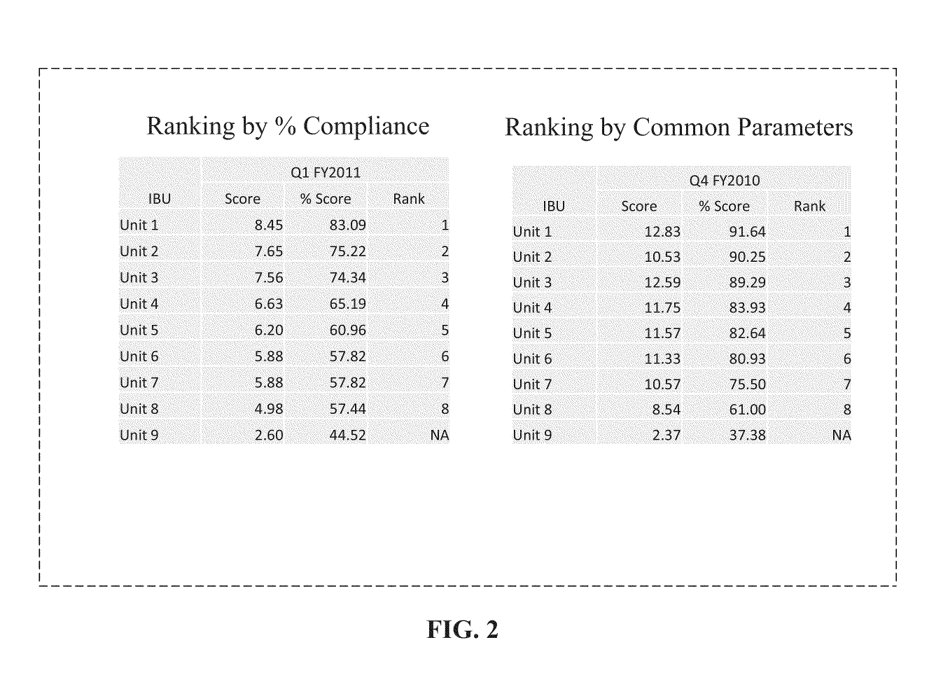

The step 120 explains how Scoring is done for each metric based on the actual data for the relevant period based on the defined business rule. The scores of the individual metrics are summed up to obtain the unit level scores. The units are then ranked based on the descending order of scores. The step 120 is also explained by referring to the FIG. 2. The entire scoring and ranking process is automated through an internally developed application called Operations Efficiency Dashboard. This process is administrated centrally and the scores are then published to all the stakeholders on quarterly and half-yearly basis.

The step 130 of FIG. 1 is Governance process in place to revisit the metrics and the business rules based on the business relevance and the compliance maturity levels. Accordingly metrics may get added, modified or removed from the overall index without altering the framework. For e.g. Initially the timelines defined in the business rule was within three days of the billing cycle end date for Time and material projects and within 3 days of milestone date for Fixed price projects. But based on the improved maturity levels the timeline is now linked to published calendar for all projects and the process of publishing calendar established for better efficiency.

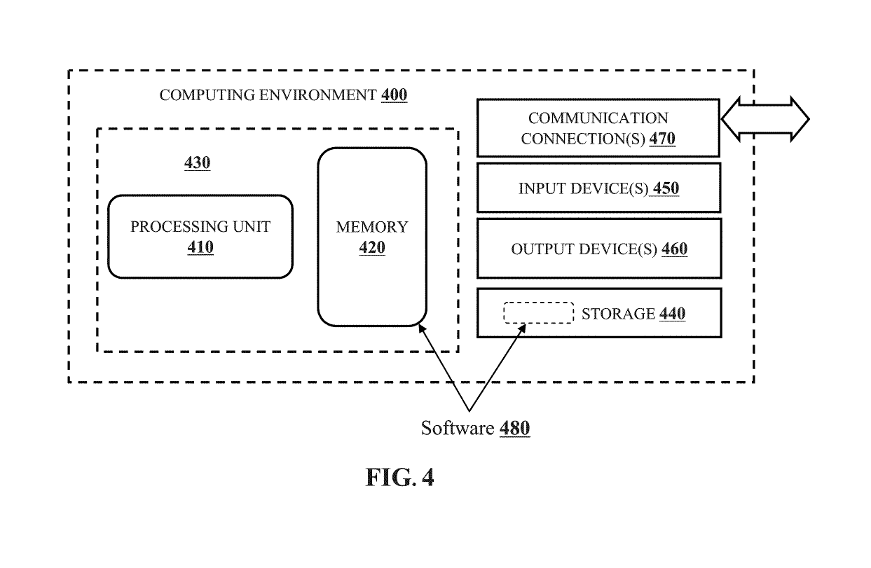

One or more of the above-described techniques may be implemented in or involve one or more computer systems. FIG. 4 illustrates a generalized example of a computing environment 400. The computing environment 400 is not intended to suggest any limitation as to scope of use or functionality of described embodiments.

With reference to FIG. 4, the computing environment 400 includes at least one processing unit 410 and memory 420. In FIG. 4, this most basic configuration 430 is included within a dashed line. The processing unit 410 executes computer-executable instructions and may be a real or a virtual processor. In a multi-processing system, multiple processing units execute computer-executable instructions to increase processing power. The memory 420 may be volatile memory (e.g., registers, cache, RAM), non-volatile memory (e.g., ROM, EEPROM, flash memory, etc.), or some combination of the two. In some embodiments, the memory 420 stores software 480 implementing described techniques.

A computing environment may have additional features. For example, the computing environment 400 includes storage 440, one or more input devices 450, one or more output devices 460, and one or more communication connections 470. An interconnection mechanism (not shown) such as a bus, controller, or network interconnects the components of the computing environment 400. Typically, operating system software (not shown) provides an operating environment for other software executing in the computing environment 400, and coordinates activities of the components of the computing environment 400.

The storage 440 may be removable or non-removable, and includes magnetic disks, magnetic tapes or cassettes, CD-ROMs, CD-RWs, DVDs, or any other medium which may be used to store information and which may be accessed within the computing environment 400. In some embodiments, the storage 440 stores instructions for the software 480.

The input device(s) 450 may be a touch input device such as a keyboard, mouse, pen, trackball, touch screen, or game controller, a voice input device, a scanning device, a digital camera, or another device that provides input to the computing environment 400. The output device(s) 460 may be a display, a television, a hand held device, a head mounted display or a Kiosk that provides output from the computing environment 400.

The communication connection(s) 470 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations may be described in the general context of computer-readable media. Computer-readable media are any available media that may be accessed within a computing environment. By way of example, and not limitation, within the computing environment 400, computer-readable media include memory 420, storage 440, communication media, and combinations of any of the above.

Having described and illustrated the principles of the disclosed embodiments, it will be recognized that the disclosed embodiments may be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

In view of the many possible embodiments to which the principles of the disclosed embodiment may be applied, we claim as our invention all such embodiments as may come within the scope and spirit of the following claims and equivalents thereto.

What is claimed is:

1. A method, implemented at least in part by a computing device, comprising of:
acquiring a plurality of business data from at least one database, wherein the plurality of business data is indicative of a pre-defined set of business parameters for one or more business functions;
performing a predefined algorithm by at least one processor over the business data and attaching a binary value against each of them, the binary value indicating the level of process compliance by each of the business parameter;
analyzing the plurality of business data by at least one processor based on the pre-defined weightage for each of the business parameters and computing a final index based on these binary values; and
generating a customizable report based on the analysis of the plurality of business data to obtain relative ranking of one or more of the business functions.

2. The method of claim 1 wherein the plurality of business data is a plurality of business objects identifying critical business functions in different domains and defining specific metrics to measure the process compliance of these business functions.

3. The method comprising of an algorithm which analyses these plurality of business objects of claim 2 and assign a binary value to each of them based on a predefined set of business rules.

4. The method of claim 3 further computes a final weight for all the plurality of business objects, wherein the final weight is the weighted summation of all the plurality of business objects.

5. The method of claim 3 further handles a plurality of exceptions while analyzing the plurality of business data by the processor.

6. The method of claim 4 further comprises assigning a rank to all business units, wherein the rank is assigned based on the final weighted score which in turn is indicative of units' respective degree of process adherence to the identified business functions.

7. The method of claim 4 wherein further data analysis result in:
computing a trend graph of process compliance against the desired dimension;
measuring the overall process compliance of an unit or of the organization as a whole; and
performing a statistical analysis of the process compliance over time.

8. The method of claim 6 wherein generating the report based on the analysis of the plurality of business data further comprises, configuring the report dynamically based on a requirement.

9. The method of claim 1 further comprises computing an operational efficiency index for one or more of:
an entire organization;
a plurality of units with the entire organization; and
a plurality of business functions.

10. The method of claim 5 further comprises configuring the metrics to be changed dynamically.

11. A system comprising:
a data acquiring module configured to acquire a plurality of business data from at least one database, wherein the plurality of business data is indicative of a pre-defined set of business parameters for one or more business functions;
a data analyzing module configured to receive input from the data acquiring module, the data analyzing module further configured analyze the plurality of business data by at least one processor based on the pre-defined weightage for each of the business parameters and the plurality of business data; and
a reporting module configured to receive data from the data analyzing module, the reporting module further configured to generate a customizable report based on the analysis of the plurality of business data to obtain relative ranking of one or more of the business functions.

12. The system of claim 11 wherein the plurality of business data is a plurality of business objects and the binary indicative value for each of the plurality of business objects.

13. The system of claim 11 wherein the data analyzing module is further configured to assign a weighted value to each of the plurality of business objects.

14. The system of claim 11 wherein the reporting module is further configured to dynamically change the report based on a requirement.

15. The system of claim 11 wherein the data analyzing module is further configured to identify critical business processes and define a metrics for each of the critical business processes, the metrics is configured dynamically.

16. The system of claim 12 wherein each of the plurality of business objects comprises a business rule for marking the plurality of business objects with the binary indicative value.

17. The system of claim 11 wherein the data analyzing module is further configured to handle a plurality of exceptions while analyzing the plurality of business data.

18. The system of claim 11 wherein the data analyzing module is further configured to compute a final weight wherein the final weight is the weighted summation of each of the plurality of business objects.

19. The system of claim 11 wherein the data analyzing module is further configured to assign a rank to the one or more business functions, wherein the rank is assigned based on the adherence of the one or more business function to a business compliance.

20. The system of claim 11 wherein the analyzing module is further configured to perform one or more of:
computing a trend graph;
measuring a performance of a business function over a time; and
performing a statistical analysis of the business function.

21. The system of claim 11 wherein the analyzing module is further configured to compute an operational efficiency of one or more of:
an entire company; and
the business functions.

22. The system of claim 11 wherein the analyzing module is further configured to predict an operational efficiency of one or more of:
the business functions; and
the entire company.

23. A computer program product, comprising a machine-accessible medium having instructions encoded thereon for enabling a processor to perform the operations of:
program code adapted for acquiring a plurality of business data from at least one database, wherein the plurality of business data is indicative of a pre-defined set of business parameters for one or more business functions;
program code adapted for analyzing the plurality of business data by at least one processor based on the pre-defined weightage for each of the business parameters and the plurality of business data; and
program code adapted for generating a customizable report based on the analysis of the plurality of business data to obtain relative ranking of one or more of the business functions.

24. The computer program product of claim 23 further comprises program code adapted for assigning a weighted value to each of the plurality of business objects based on a binary indicative value.

25. The computer program product of claim 23 further comprises program code adapted for configuring the report dynamically based on a requirement.

26. The computer program product of claim 23 further comprises program code adapted for identifying critical business processes and defining a metrics for each of the critical business processes.

27. The computer program product of claim 24 further comprises program code adapted for defining a business rule for marking the plurality of objects with a binary indicative value.

28. The computer program product of claim 23 further comprises program code adapted for identifying critical business processes and defining a metrics for each of the critical business processes, wherein the metrics is changed dynamically.

29. The computer program product of claim 23 further comprises program code adapted for defining a business rule for marking the plurality of business objects with a binary indicative value.

30. The computer program product of claim 23 further comprises program code adapted for handling a plurality of exceptions while analyzing the plurality of business data by the processor.

31. The computer program product of claim 23 further comprises program code adapted for computing a final weight for all the plurality of business objects, wherein the final weight is the weighted summation of all the plurality of objects.

32. The computer program product of claim 23 further comprises program code for assigning a rank to the one or more business functions, wherein the rank is assigned based on the adherence of the one or more business function to a business compliance.

33. The computer program product of claim 23 further comprises program code adapted for analyzing one or more of:
computing a trend graph;
measuring a performance of a business function over a time; and
performing a statistical analysis of the business function.

34. The computer program product of claim 23 further comprises program code adapted for computing an operational efficiency of one or more of:
an entire company; and
the business functions.

35. The computer program product of claim 23 further comprises program code adapted for predicting an operational efficiency of one or more of:
the business functions; and
the entire company.
